(19) United States
(12) Patent Application Publication
(10) Pub. No.: US 2007/0215636 A1
(43) Pub. Date: Sep. 20, 2007

(54) PUMPING JOINT

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/164,551

(22) Filed: Nov. 29, 2005

(30) Foreign Application Priority Data
Dec. 15, 2004 (TW) 93138843

(51) Int. Cl. B67D 5/00

(52) U.S. Cl. 222/3

(57) ABSTRACT

A joint includes a tube, a needle and a driver. The tube receives a valve housing in an airtight manner. The needle includes a pusher movable in the tube in order to push open a check valve in the valve housing and an anchor for insertion in a flexible pipe of a pump. The driver can be rotated around the needle and moved in the tube in order to drive the pusher.

### BACKGROUND OF INVENTION

1. Field of Invention

The present invention relates to a pumping joint.

2. Related Prior Art

Referring to FIG. 9, there is shown a conventional joint 80 consisting of a needle 81 and a ring 82. The needle 81 includes an anchor for insertion and locking in a flexible pipe 83. To this end, the anchor includes a serrate profile. A ferrule 811 is provided around the flexible pipe 83 in order to keep the anchor locked in the flexible pipe 83. The ring 82 is connected to the needle 81 in a rotational and airtight manner. A thread 821 and a pusher 822 are formed on the interior of the ring 82. A seal 823 is provided around the pusher 822. The thread 821 of the ring 82 is engaged with a thread 892 of a valve housing 89 of an air shock for example. The pusher 822 pushes open a check valve 891 in the valve housing 89 before the seal 823 abuts the valve housing. Therefore, air leaks between the ring 82 and the valve housing 89, and this is undesirable.

Referring to FIG. 10, there is shown another conventional joint 90 for improving the conventional joint 80. The joint 90 includes a needle 91 and a tube 92. The needle 91 includes an anchor 914, a pusher 911 opposite to the anchor 914 and a thread 912 between the anchor 914 and the pusher 911. The anchor 914 is inserted and locked in a flexible pipe 93. To this end, the anchor 914 includes a serrate profile. A ferrule 913 is provided around the flexible pipe 93 in order to keep the anchor 914 locked in the flexible pipe 93. The tube 92 defines a first chamber 922, a second chamber 921 and an aperture through which the chambers 922 and 921 are in communication with each other. Formed on the wall of the first chamber 922 is a thread 924 for engagement with the thread 912 of the needle 91. Formed on the wall of the second chamber 921 is a thread for engagement with a thread of a valve housing 99 of an air shock for example. Provided in the second chamber 921 is a seal 923 for sealing contact with the valve housing 99.

Referring to FIG. 11, a user has to rotate an entire pump 94 in order to rotate the needle 91, and this is troublesome. Referring to FIG. 12, the seal 923 in airtight contact with the valve housing 99 before the pusher 911 pushes open a check valve 991 in the valve housing 99. Thus, there is no leakage of air between the tube 92 and the valve housing 99.

Referring to FIG. 14, the pusher 911 pushes open a check valve 991 in the valve housing 99. Referring to FIG. 13, it may however be difficult for the user to check a pressure gauge 95 of the pump 94 since he or she does not have any control over the angular position of the pump 94.

The present invention is therefore intended to obviate or at least alleviate the problems encountered in prior art.

### SUMMARY OF INVENTION

According to the present invention, a joint includes a tube, a needle and a driver. The tube receives a valve housing in an airtight manner. The needle includes a pusher movable in the tube in order to push open a check valve in the valve housing and an anchor for insertion in a flexible pipe of a pump. The driver can be rotated around the needle and moved in the tube in order to drive the pusher.

The primary advantage of the joint of the present invention is the convenience that the driver is rotated instead of the entire pump.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a pump including a joint according to the preferred embodiment of the present invention.

FIG. 2 is an exploded view of the pump shown in FIG. 1.

FIG. 3 is an enlarged cross-sectional view of the joint shown in FIG. 1.

FIG. 4 is a cross-sectional view of the joint in another position than shown in FIG. 3.

FIG. 5 is a cross-sectional view of the joint in another position than shown in FIG. 4.

FIG. 6 is a perspective view of another pump including the joint shown in FIG. 1.

FIG. 7 is an exploded view of the pump shown in FIG. 6.

FIG. 8 is a reduced top view of the pump shown in FIG. 6.

FIG. 9 is a cross-sectional view of a conventional joint.

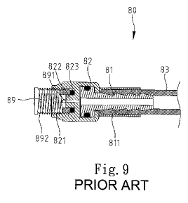

FIG. 10 is a cross-sectional view of another conventional joint.

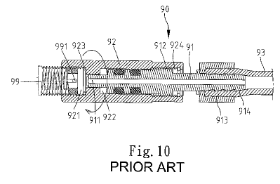

FIG. 11 is a side view of a pump using the joint shown in FIG. 10.

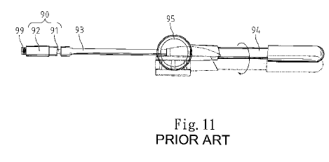

FIG. 12 is a cross-sectional view of the joint in another position than shown in FIG. 10.

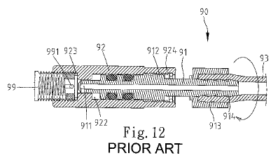

FIG. 13 is a side view of the pump in another position than shown in FIG. 11.

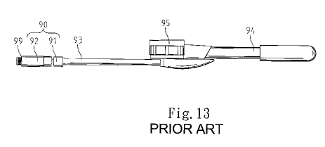

FIG. 14 is a cross-sectional view of the joint in another position than shown in FIG. 12.

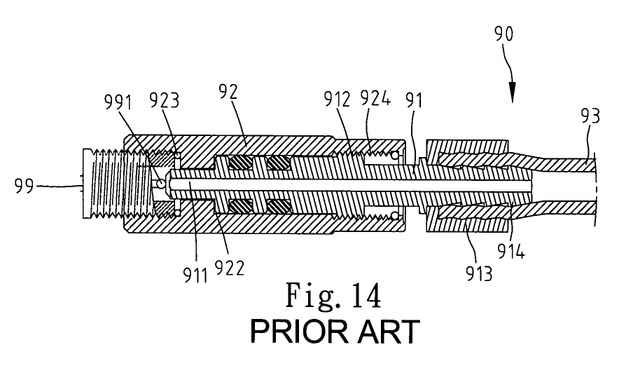

### DETAILED DESCRIPTION OF PREFERRED EMBODIMENT

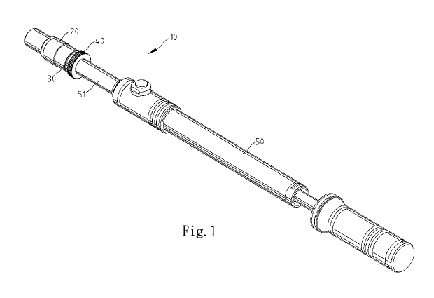

Referring to FIG. 1, there is shown a pump 50 including a joint 10 according to the preferred embodiment of the present invention. The joint includes a tube 20, a needle 30 and a driver 40.

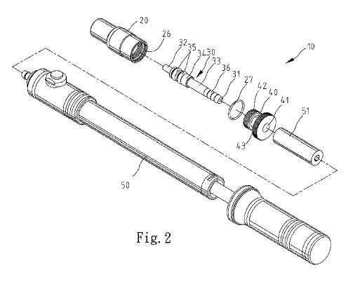

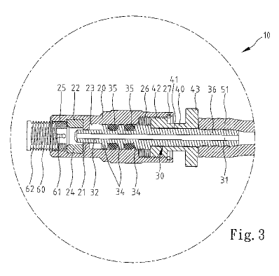

Referring to FIGS. 2 and 3, the needle 30 defines a channel 31 through which air can go. The needle 30 includes an anchor 36, a neck 33 next to the anchor 36, a slide 34 next to the neck 33 and a pusher 32 next to the anchor 36. The diameter of the slide 34 is larger than that of the neck 33. The anchor 36 is inserted and locked in a flexible pipe 51 of the pump 50. To this end, the anchor 36 includes a serrate profile. A ferrule may be provided around the flexible pipe 51 in order to keep the anchor 36 locked in the flexible pipe 51. A plurality of seals 35 is provided around the slide 34.

The tube 20 includes an annular partition 21 formed on the interior, thus defining two chambers 23 and 22 in communication with each other through an aperture defined in the annular partition 21. The chamber 23 of the tube 20 contains the slide 34 of the needle 30. The wall of the chamber 23 is in contact with the slide 34 in a sliding manner and in an airtight manner due to the use of the seals 35. A thread 26 is formed on the wall of the chamber 23. Formed on the wall of the chamber 22 is a thread 25 for engagement with a thread 62 on a valve housing 60 of an air shock for example. Provided in the chamber 22 is a seal 24 for sealing contact with the valve housing 60.

The driver 40 is hollow, i.e., it defines a chamber 41 for receiving the needle 30. Formed on the exterior of the driver 40 is a thread 42 for engagement with the thread 26 of the tube 20. Also on the exterior of the driver 40 is formed a wheel 43 for facilitating the rotation of the driver 40. Attached to the wall of the chamber 23 of the tube 20 is a ring 27 for retaining the driver 40 partially in the chamber 23 of the tube 20. The driver 40 is provided around the neck 33.

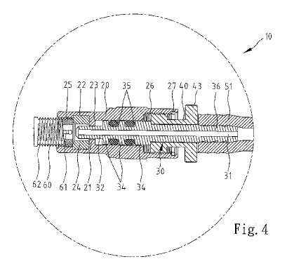

Referring to FIG. 4, the thread 25 of the tube 20 is engaged with the thread 62 of the valve housing 60. Thus, a user can move the tube 20 along the valve housing 60 by means of rotating the tube 20. The user can finally abut the seal 24 against the valve housing 60. This occurs before the pusher 32 pushes open a check valve 61 in the valve housing 60. The user does not have to rotate the pump 50 at all.

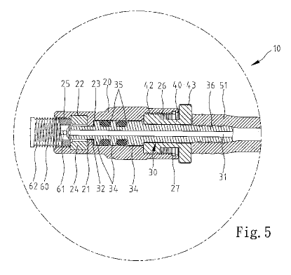

Referring to FIG. 5, as the thread 42 of the driver 40 is in engagement with the thread 26 of the tube 20, the user can move the driver 40 relative to the tube 20 by means of rotating the driver. The driver 40 in turn pushes the needle 30 by the slide 34. Finally, the pusher 32 pushes open the check valve 61. Thus, pressurized air can be pumped into the air shock through the valve housing 60 past the check valve 61. The user does not have to rotate the pump 50 at all. The annular partition 21 helps stop the slide 34.

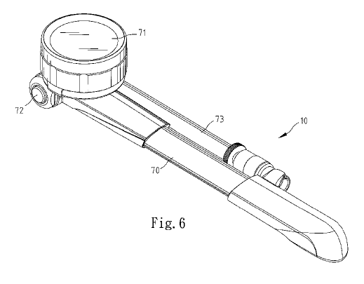

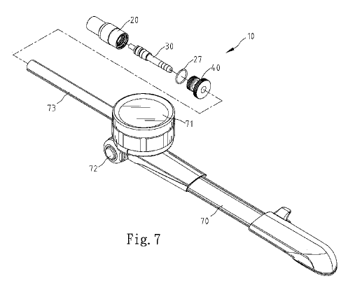

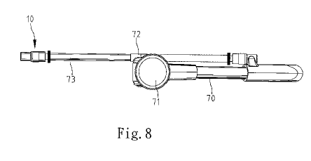

Referring to FIGS. 6 through 8, there is shown another pump 70 including the joint 10 according to the preferred embodiment of the present invention. The pump 70 includes a pressure gauge 71, a pivotal connector 72 and a flexible pipe 73 connected thereto through the pivotal connector 72.

The pumps 50 and 70 are only taken as examples. Many other pumps can be equipped with the joint 10.

An advantage of the joint 10 is the convenience that the driver 40 is rotated instead of the entire shock pump. When used in the pump 70 with the pressure gauge 71, the joint 10 exhibits another advantage, i.e., the convenience in letting the user to check the pressure gauge 71.

The present invention has been described through the description of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A joint comprising:
a tube for receiving a valve housing in an airtight manner;
a needle comprising a pusher movable in the tube in order to push open a check valve in the valve housing, a slide for sliding in the tube and an anchor for insertion in a flexible pipe of a pump;
at least one seal around the slide in order to ensure an airtight relation between the slide and the interior of the tube; and
a driver for rotation around the needle and movement in the tube in order to drive the pusher.

2. The joint according to claim 1 comprising two seals around the slide in order to ensure an airtight relation between the slide and the interior of the tube.

3. The joint according to claim 1 wherein the slide includes a diameter larger than that of the pusher, wherein the tube comprises an annular partition on the interior thereof for stopping the movement of the needle.

4. The joint according to claim 3 wherein the annular partition divides the space in the tube into a first chamber for receiving the valve housing and a second chamber for receiving the needle so that the pusher of the needle extends into the first chamber from the second partition chamber.

5. The joint according to claim 4 wherein the tube comprises a thread on the wall of the first chamber for engagement with a thread on the valve housing.

6. The joint according to claim 4 further comprising a seal in the first chamber against the annular partition for airtight contact with the valve housing.

7. The joint according to claim 4 wherein the driver comprises a thread, wherein the tube comprises a thread on the wall of the second chamber for engagement with the thread for the driver.

8. The joint according to claim 7 wherein the driver further comprises a wheel thereon for facilitating the rotation thereof.

9. The joint according to claim 7 wherein the tube comprises a thread on the wall of the first chamber for engagement with a thread on the valve housing.

10. The joint according to claim 4 comprising a ring attached to the wall of the second chamber in order to retain the driver partially in the tube.

11. The joint according to claim 1 wherein the anchor comprises a serrate profile.

12. The joint according to claim 1 wherein the driver comprises a thread, wherein the tube comprises a thread for engagement with the thread for the driver.
